(19) United States
(12) Patent Application Publication
(10) Pub. No.: US 2005/0103577 A1
(43) Pub. Date: May 19, 2005

(54) Elevator door safety control device

(76) Inventor: Robert A. Warner, New Port Richey, FL (US)

Correspondence Address: MCDERMOTT, WILL & EMERY, 600 13th Street, N.W., Washington, DC, 20005-3096, US

(21) Appl. No.: 10/715,849

(22) Filed: Nov. 19, 2003

(51) Int. Cl. B66B 13/26

(52) U.S. Cl. 187/317

(57) ABSTRACT

An elevator door closure control system and method are provided and include an elevator light screen signal detector module having first and second electrical connectors, a signal detection element configured to detect a carrier wave control signal and output a signal in response thereto, and a switch configured to change from a first state to a second state (or vice versa) in response to a signal detection element output signal or a control signal from a controller. The electrical connectors permit connection of the module to a light screen receiver array output and an elevator door controller input so as to place the switch in series with the receiver array output. The switch second state causes, in one aspect, the elevator doors to remain open for a preset time or until the light source array detects the arrival of an appliance, person, or object in its beam path(s).

### TECHNICAL FIELD

The disclosure relates generally to control devices for elevator doors. The disclosure relates more particularly to control devices for controlling the closing of elevator doors.

### BACKGROUND

Door closure in conventional elevators is typically effected by mechanical safety edges, which stop and/or reverse door closure when a leading edge of the door contacts an impediment to movement of a minimum force, or photoelectric light sensors, which provide non-contact sensing capability and stop and/or reverse door closure when the continuity of a light beam is interrupted. Photoelectric light screens are particularly prevalent and comprise a “2D” light source array, typically containing a plurality (e.g., 64) of Infra-Red (IR) Light Emitting Diodes (LEDs), and a receiver array, typically containing a plurality (e.g., 32) of detector photoelectric diodes or photodetectors that receive light beams from the IR LEDS (e.g., 64 light beam paths converging on 32 photodetectors). A light screen light source array 10 bearing a plurality of LEDs 12 and receiver array 20 comprising a plurality of photoelectric detectors 22 are shown installed on the doors 15, 25 of a center-parting elevator in FIG. 1.

The physical configuration of the photoelectric light screens follows from the elevator configuration. For elevators equipped with center parting doors, the light source arrays are mounted (e.g., using “L” brackets) near the leading edge of the opposing doors of the elevator car. Each LED light beam is pointed across the opening of the elevator door at a selected opposing photodetector, which may be disposed at the same or a different height than that of the LED emitting the light beam.

This 2D light screen output is, itself, routed to an elevator door control input such as, but not limited to, a programmable logic controller, elevator door operator inputs, a direct connection to a power supply relay or other type of elevator control relay, various synching devices used, and/or equivalents thereof, which control closure of the elevator and hoistway door(s). A person can thus stop the door(s) from closing by breaking one or more of the light beam paths. For elevators equipped with side parting doors, the light source array is attached to the leading edge of the car door and the opposing receiver array is attached to the door jamb. In either configuration, both arrays are attached to and travel with the elevator car, or cab.

When an elevator car arrives at a floor selected by a passenger in the elevator, the elevator control system signals the door(s) to open. The photoelectric light screen is not associated with this operation. To open the elevator car door, a mechanical linkage attached to the elevator door is driven, such as by a motor housed on a top of the cab. The elevator cab door, in turn, unlatches the closed hoistway door and pulls it open. The elevator control system allows both sets of doors (i.e., the elevator doors and the temporarily connected hoistway doors) to stay open for a preset length of time (e.g., 7 seconds) before closing.

For a conventional light-based control system, the only means by which the door closure can be automatically prevented is by interruption of a light source beam, such as by a person, appliance, or object passing between a light source array and an associated detector. Since the light source arrays are attached to the elevator door(s), there is a gap of approximately 2-4 inches between the photoelectric light screen and the hoistway or outer door(s). This gap can be problematic if exiting passengers or tardy entering passengers attempt to stop and/or reverse the closing door(s) by placing their hands into the path of the closing hoistway door(s) just prior (e.g., within less than about a foot) to total closure. As noted above, automatic closure of the hoistway door(s) is controlled by the elevator door mechanism(s) which is, in turn, controlled by the photoelectric light screen. Such attempts to intercede in the automatic door closure, at best, simply succeed or fail to stop and/or reverse the closing. There remain frequent instances of damage and serious injuries caused by closing elevator and/or hoistway doors.

In an attempt to provide added protection to passengers approaching the hoistway door(s), some manufacturers have added a photoelectric proximity detection system into the existing housing of the light screen arrays, creating a “3D” detection system. The 3D proximity system attempts to detect passengers approaching the elevator entrance by projecting IR light outwardly around the hoistway door(s) so as to cause such light to be reflected off of persons or objects in the immediate vicinity of the hoistway door(s) and to an array of detectors. Although useful to some degree, this approach suffers from many practical deficiencies and is not considered to provide a reliable method of detection. For example, the color, material, and surface of the object or person which reflects the light beam will strongly influence the scattering and reflection of the light (e.g., dark-colored clothing reflects less light than light-colored clothing), which requires a careful sensitivity adjustment to detect persons or objects entering the elevator, but discriminating against false detections of other persons or objects located in the landing or hallway. An additional deficiency is the inability of the 3D system to reliably detect people or objects positioned off to the side of the closing door(s) as the door(s) is closing.

More significant deficiencies in the 3D system include an auto-disable timer that disable the proximity 3D system after lapse of a pre-determined dwell time and reduction in coverage of the 3D system as the door(s) close, which impedes the system's ability to sense potential passengers as they approach the hatchway door(s). At some point prior to full closure of the hoistway door(s) (i.e., within about 8″ to closure), the 3D system must be disabled since the hoistway door(s) lead the elevator car door(s) and would be sensed by the 3D system. Thus, as the hoistway door(s) close, the field of view is obscured by the hoistway door(s) and the 3D system is disabled, persons may still be tempted to insert hands, limbs, or other body parts into the rapidly decreasing gap between the hoistway door(s), which can cause serious injury.

### SUMMARY

In one aspect, an elevator door control system is provided and comprises an elevator door controller for controlling closure of an elevator door, a light source array attachable to an elevator car, a light beam receiver array attachable to an elevator car, the light beam receiver array comprising an output to an elevator door controller, a switch provided in series with the light beam receiver array output to the elevator door controller, and a signal detector disposed on the light beam receiver array to detect a control signal borne by a carrier wave emitted by a transmitter and configured to output a signal to a controller or the switch in response to a detected control signal. The switch, being responsive to the signal output by the signal detector, changes from a first or second state to another of the first state or second state.

In another aspect, an elevator light screen signal detector module comprises a first electrical connector, a second electrical connector, at least one signal detection element configured to detect a carrier wave bearing a control signal and configured to output a signal in response thereto, and a switch configured to change from a first or second state to another of the first or second state in response to a signal output by the signal detection element or in response to a control signal from a controller receiving the signal output by the signal detection element. The first electrical connector is configured to permit electrical connection of the light screen signal detector module to an output of a light screen receiver array and the second electrical connector is configured to permit electrical connection of the light screen signal detector module to an input of an elevator door controller. Connection of the first electrical connector of the light screen signal detector module to an output of a light screen receiver array and connection of the second electrical connector of the light screen signal detector module to an input of an elevator door controller places the switch in series with the output of a light screen receiver array.

In still another aspect, an elevator door light screen receiver array comprises a plurality of light detecting photodiodes, each of the photodiodes being configured to provide an output signal in response to an incident light beam and a light beam receiver array switch configured to assume a first state when each of the plurality of detecting photodiodes provides an output signal and configured to assume a second state when any one of the plurality of light detecting photodiodes does not provide such output signal. A switch is provided in series with the light beam receiver array switch. An output electrical connector is connected to an output the light beam receiver array switch and/or the switch, the output electrical connector being configured for electrical connection to an elevator door controller for controlling closure of an elevator door. A signal detector is integrated with the light beam receiver array and is configured to output a signal in response to a detected control signal borne by a carrier wave to change a state of the switch from a first or second state to another of the first or second state.

Still other aspects include a method of controlling closure of an elevator door comprising the steps of emitting a first carrier wave bearing a first control signal from a transmitter, using the first control signal to energize a switch to perform a temporary enabling and/or disabling of an elevator door controller, the energization of the switch causing the elevator door controller drive an elevator door toward an open position or to maintain an elevator door in an open position, emitting a second carrier wave bearing a second control signal from a transmitter, and using the second control signal to deenergize the switch to perform a temporary disabling and/or enabling of the elevator door controller, as appropriate, the energization of the switch causing the elevator door controller to drive the elevator door toward a closed position.

Yet other aspects include methods of controlling closure of an elevator door comprising the steps of emitting a carrier wave bearing a control signal from a transmitter, using the control signal to energize a switch provided in series to an output of a 2D light screen, the energization (or deenergization) of the switch performing a temporary enabling and/or disabling of an elevator door controller, as appropriate, and causing the elevator door controller drive an elevator door toward an open position or to maintain an elevator door in an open position, and using an output from a 2D light screen to deenergize (or energize) the switch and correspondingly provide the output of the 2D light screen as a control input to the control the elevator door controller.

Additional features and advantages of the invention will become readily apparent to those skilled in the art from the following detailed description, wherein only several embodiments or applications of the present concepts are shown and described, simply by way of illustration of modes contemplated for carrying out the invention. As will be realized, the present concepts are capable of other and different embodiments, and its several details are capable of modifications in various obvious respects, all without departing from the spirit of such concepts. Accordingly, the drawings and description are illustrative in nature and are not limiting.

### BRIEF DESCRIPTION OF THE DRAWINGS

FIG. 1 shows an examples of a conventional door edge light screen system installed on an elevator with center-parting doors.

FIGS. 2(a)-2(b) show images of an isolated door edge light screen system incorporating a 4D detector and latch system in accord with the present concepts and FIGS. 2(c)-2(d) depict such door edge light screen system including a 4D detector and latch system provided with a center opening door and a side opening door, respectively.

FIGS. 3(a)-(c) respectively show block diagrams of an elevator door edge light screen system incorporating a 4D detector and latch system and a circuit diagram for a 4D detector and latch system in accord with the present concepts.

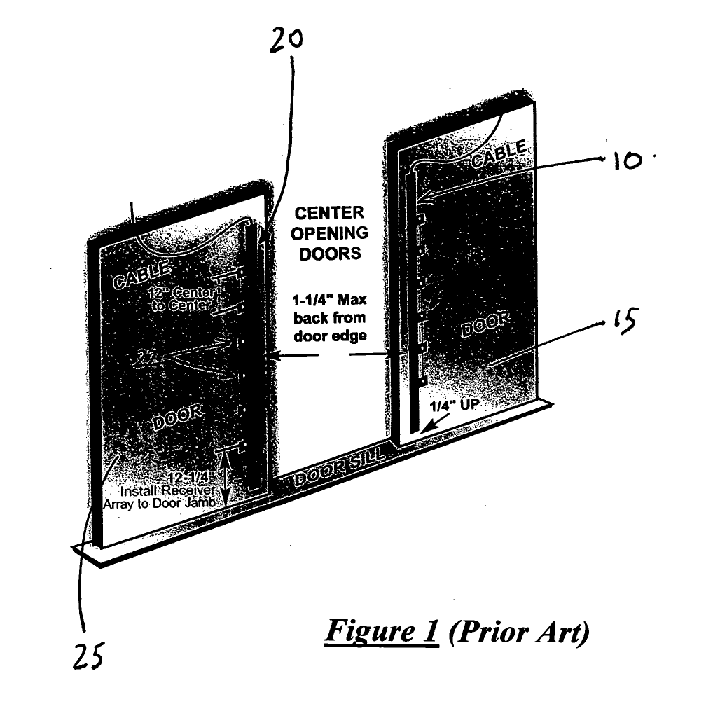

### DETAILED DESCRIPTION

An object of the present disclosure is to provide a device integratable into existing 2D arrays, so as to provide guaranteed safe passage of passengers, including those of impaired mobility, and objects (e.g., luggage racks, service carts, refuse containers, hospital beds, gurneys, portable hospital equipment, etc.) past both the hoistway and elevator car door(s) while entering and exiting the elevator.

The system in accord with the present disclosure utilizes a transmitter or remote control device, such as a portable battery-operated transmitter, to emit a carrier wave including but not limited to an electromagnetic wave (e.g., IR, radio frequency (RF), or microwave) or mechanical or compressional waves (e.g., ultrasonic, sonic, or subsonic). The aforementioned carrier wave provides a control signal to a latching system, described herein generally as a “4D detector,” “4D receiver,” “4D detection and latch system,” or the like, which is advantageously integrated into a conventional 2D light screen.

In one general aspect, the 4D detection and latch system comprises a switch or latch provided in series to the 2D light screen output (e.g., NPN output or PNP output). This 2D light screen output is, itself, conventionally routed to an elevator door control input such as, but not limited to, a programmable logic controller, elevator door operator inputs, direct connection to a power supply relay or other type of elevator control relay, various synching devices used, and/or equivalents thereof, which control closure of the elevator and hoistway door(s). Implementation of the latch in series to the 2D light screen output in accord with the presently disclosed concepts provides, in combination with the transmitter, a remote means by which the elevator door closure may be controlled by the transmitter. Activation of the transmitter causes the latch to change state to energize or de-energize any of the aforementioned elevator door control inputs, as appropriate, to control closure of the elevator and hoistway door(s).

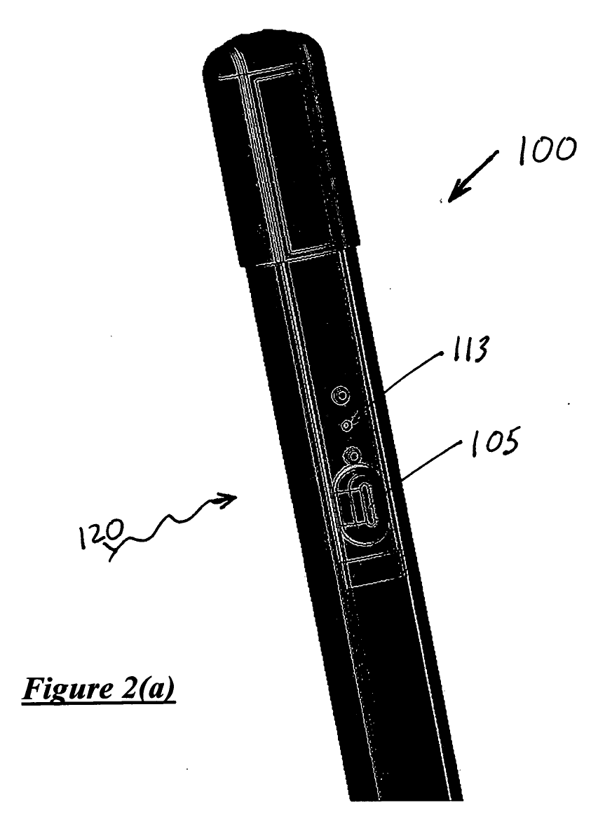

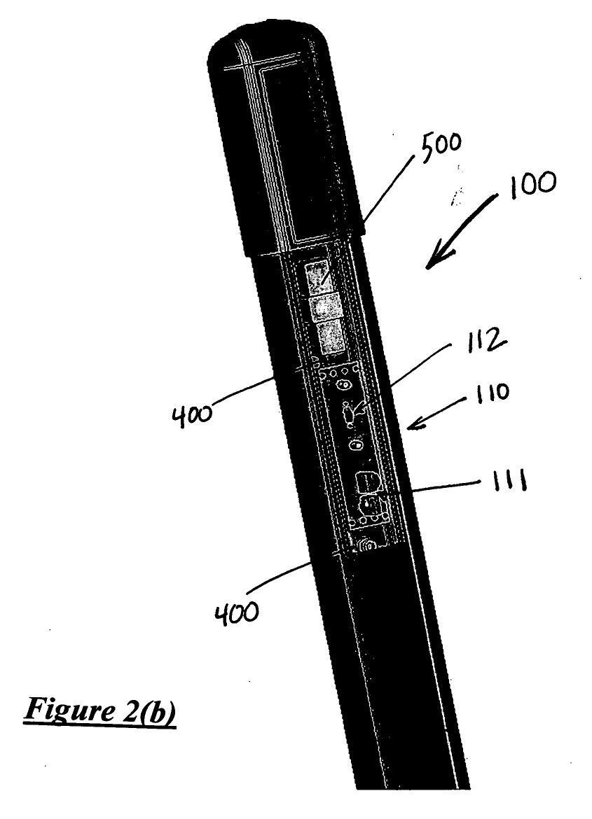

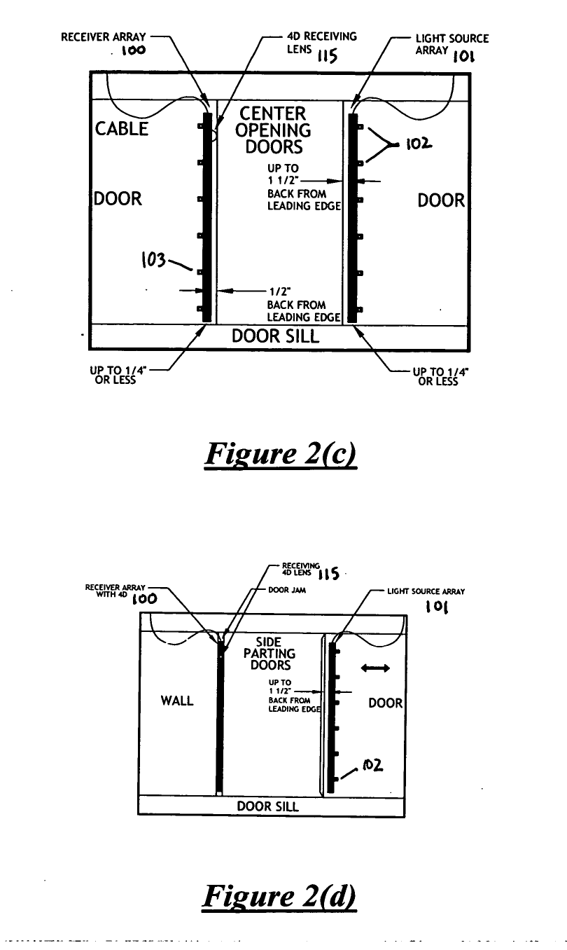

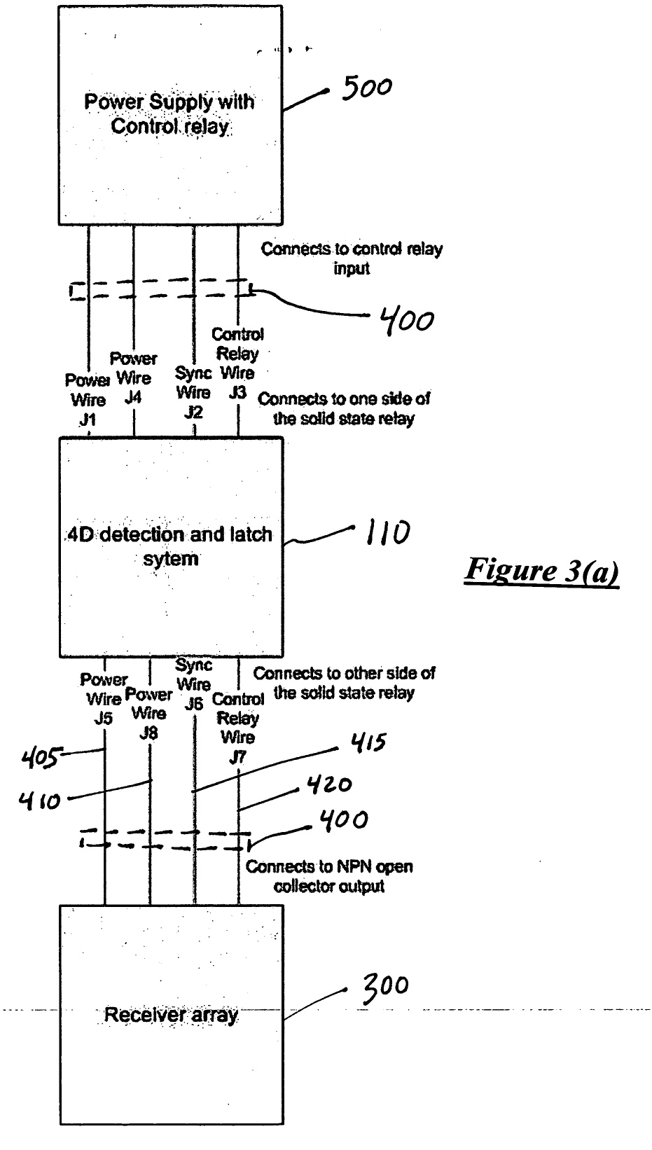

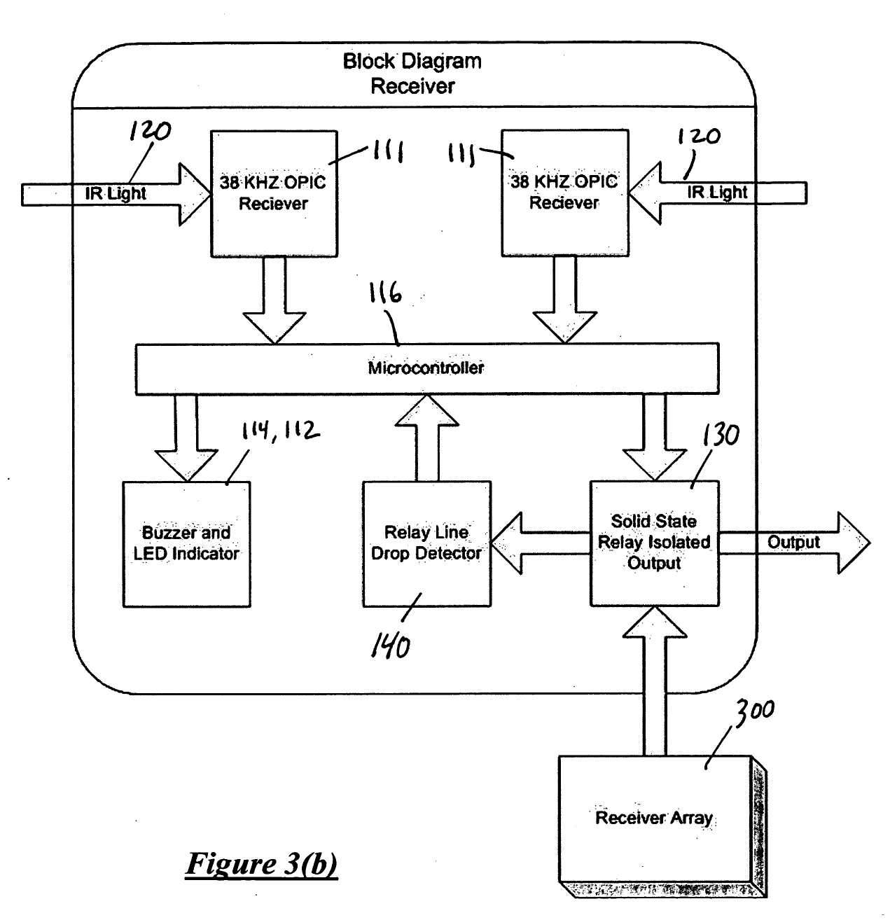

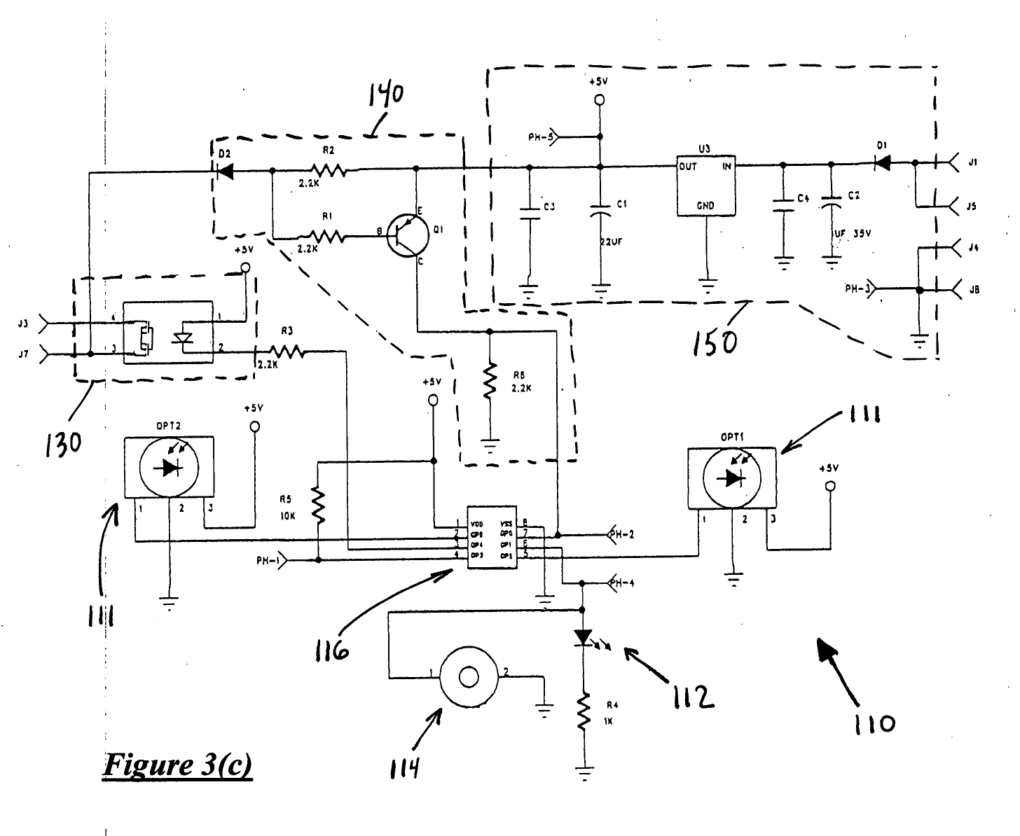

In one aspect, a 4D detector 110, which may comprise an IR detector adapted to receive the signal output from the aforementioned transmitter, is integrated into or mounted at a top portion of a conventional 2D light screen 100, preferably a Leading Edge™ elevator door edge manufactured by Tri-Tronics, such as shown in FIGS. 2(c)-2(d). As more clearly shown in FIGS. 2(a)-(b), the 4D detector 110 is disposed behind a window or aperture 115 at a top portion of a light screen 100 receiver array. Placement of the 4D detector 110 in this manner permits integration of the 4D detector into the existing array structure, inclusive of the same array, housing, cables, power supply, and output relay, as described below. This component integration is reflected in FIG. 3(a).

FIGS. 3(a)-3(b) show block diagrams of an elevator door edge light screen system incorporating a 4D detector and latch assembly in accord with the present concepts. A standard 2D light screen, such as a Leading Edge™ elevator door edge manufactured by Tri-Tronics, comprises a light beam receiver array 300 (e.g., a 32 channel array) and a power supply 500 with a control relay.

The 2D detection system comprises conventional electronics to transmit the plurality of light beams (e.g., 64 beams) from a light source array's 101 light emitting devices (e.g., diodes) 102 across an elevator door threshold and to detect via a plurality of photodetectors 103 and determine whether or not any of the light beams are broken by an appliance, object or body part. Such 2D systems typically comprise an NPN open collector transistor electrically connected to the power supply 500 control relay via associated wires so as to activate or deactivate the control relay. In one aspect, when the NPN transistor is conducting to ground the relay in the power supply 500 is pulled in and when the NPN transistor is not conducting to ground the relay in the power supply is dropped. In the conventional set-up, a 4-wire control cable 400 directly connects the power supply 500 control relay input to the receiver array 300, such as through the receiver array amplifier board.

In accord with the present concepts, the receiver array 300 is connected to 4D detection and latch system board 110 by a first 4-wire control cable 400 and the 4D detection and latch system board 110 is connected to the power supply 500 control relay by a second 4-wire control cable 400, as shown in FIG. 3(a). The 4-wire control cables 400 carry power on two power wires 405, 410. Power is passed to the 4D detection and latch system board 110, as well as the receiver array 300 amplifier board through the 4-wire control cables 400 power wires 405, 410. The transmitter synchronization signal is transmitted through a synchronization or sync wire 415 and passes through the 4D detection system board 110 unencumbered. The control relay wire 420 is, however, connected through the 4D detection and latch system 110 through connections J3 and J7, as shown in more detail in FIG. 3(c).

FIG. 3(c) shows one example of a 4D detection and latch system board 110 in accord with the present concepts. The control relay wire 420, which passes a relay control signal between receiver array 300 and the power supply 500 control relay, is connected to a single-pole, single-throw solid-state relay (SSR) 130 on the 4D detection and latch system board 110 via connections J3 and J7. Thus, SSR 130 is connected in series with the open collector NPN transistor of the receiver array 300 amplifier board and the control relay input of the power supply 500, or other elevator door control input, as applicable.

In the exemplary circuit depicted in FIG. 3(c), SSR 130 performs two functions. First, when SSR 130 is in the closed state, control of the power supply 500 relay is passed to the receiver array 300 amplifier board. This represents the inactive state of the 4D detection and latch system 110 and provides the overall system with normal 2D operation. When SSR 130 is in the open state, the power supply 500 relay is de-energized and the receiver array 300 does not control the power supply relay. Thus, when SSR 130 is opened following receipt of a control signal borne by a carrier wave 120 emitted from a remote transmitter (e.g., IR remote), the 4D detection and latch system 110 opens the line, dropping the relay in the power supply 500. As configured, the 4D detection and latch system 110 remains in this SSR 130 open state for 15 seconds or until the 2D system detects an object, appliance, or body part by means of the relay line drop detector 140. When an object or body part is detected by relay line drop detector 140, the NPN transistor in the receiver array 300 opens and the 4D detection and latch system 110, responding thereto, cancels the 15-second latch timer and closes the SSR 130 of the 4D system, thereby passing control back to the receiver array and letting the 2D edge 100 control closure of the door. In accord with the present concepts, either the conventional 2D edge 100 or the 4D system 110 can open the line (e.g., 420) and drop the power supply 500 control relay to open the elevator doors (i.e., both the elevator door(s) and hoistway door(s)) or maintain the elevator doors in an open position.

The 4D detector 110 includes, in one aspect, a photodetector or light detecting elements 111. These light detecting elements 111 may advantageously comprise an optical integrated circuit device (e.g., an OPIC device) or the like, which provides an integrated signal processing capability to directly decode and/or encode a signal borne by an incident carrier wave. Although FIG. 3(b) shows an example wherein light detecting elements 111 are particularly attuned to a range of about 38 kHz, this example is non-limiting and the light detecting elements 111 may be adapted to detect any frequency or range of frequencies of carrier wave (e.g., IR). Such signal processing capability may also be provided by other circuit elements or controllers including, but not limited to, microprocessor 116. The 4D detector 110 uses the light detecting elements 111 and integrated signal processing capability to decode and/or otherwise use the carrier waves 120 (e.g., a modulated IR carrier wave) bearing control signals incident thereto to control the latch 130 and, correspondingly, closure of the elevator and hoistway door(s).

As shown in FIG. 2(b), one light detecting element 111 is directed outwardly from the elevator while another light detecting element 111 is optionally directed inwardly toward an interior of the elevator. Although a single, forward-facing light detecting element 111 provides sufficient detection capability of an incoming carrier wave 120 bearing a control signal, the rearward-facing light detecting element permits additional latitude for receipt of reflected carrier waves, such as from an interior of an elevator, or for activation of the 4D detector 110 from an interior of the elevator. The second light detecting element 111 could be optionally eliminated or re-oriented or additional light detecting elements could be used in accord with the present concepts. An indicator light 112 (e.g., LED) is also optionally provided behind a window 113. This indicator light 112 and an optional buzzer 114 associated therewith serve, as shown in the circuit diagram of FIG. 3(c), to acknowledge receipt of a carrier wave control signal 120, or to indicate a desired state or event.

In operation, the receiver 110 is triggered by pointing a remote control (e.g., an IR remote) in the direction of the receiver array(s) of the light screen 100 and outputting a signal or carrier wave 120 therefrom. The 4D detector 110 light detecting element(s) 111 senses the carrier wave 120 control signal (e.g., modulated IR emission) emitted from the transmitter and outputs a signal representative of the control signal to microcontroller 116. The microcontroller 116 may comprise any conventional microcontroller of appropriate processing capability such as, but not limited to, a 3.3 V or 5V PIC12F629 8-pin CMOS flash-based field reprogrammable device. Receipt of such control signal 120 may optionally be acknowledged by an audible and/or a visible confirmation signal, such as by the aforementioned indicator light 112 or buzzer 114 or by a like device (e.g., LED or speaker) integrated into the remote control device.

The latched circuit in accord with the present concepts, an example of which comprising receiver array 300, 4D detector 110, and power supply 500 relay is shown in FIG. 3(a), can be reset in a variety of ways.

In one aspect, a person requiring extra time to facilitate safe passage into or out of the elevator may use a remote control device (e.g., IR or RC) to activate a 4D detector and latch system 110, as disclosed herein. As one example, the presently disclosed 4D detector and latch system 110 could be advantageously used in a hospital setting. Hospital nurses and orderlies are frequently required to use elevators to transport portable pieces of equipment or to transport a patient in a bed or wheelchair. In accord with the 4D detector and latch system 110, a nurse or orderly would push the elevator call button in the usual manner and await the arrival of the elevator at the landing. When the door(s) open, a conventional elevator dwell timer will start counting down a predetermined interval of time, which may be as little as seven seconds (e.g., particularly in high traffic areas and/or peak usage times), and will then start closing the elevator doors. During this predetermined interval, the elevator passengers (if any) enter and leave the elevator. However, it is not unusual for the time required by people to enter and leave the elevator to exceed the available dwell time and the doors will start to close while people are still trying to enter and/or exit the elevator.

In this circumstance, a nurse or orderly is conventionally placed in the position of attempting to break the light beams in the 2D system or having to ask someone to stop the doors for assistance. Although generally effective, success depends either upon the ability of the nurse or orderly to manage the elevator, as well as the conveyed person or object or upon the caprice, dexterity, strength, and/or hand/eye coordination of strangers. This is a cumbersome, and possibly embarrassing or anxiety producing, way to enter the elevator. Moreover, the aforementioned risks of injury or property damage cause by closure of elevator and/or hoistway doors in conventional 2D setups are not addressed by these stop gap actions. In accord with the disclosed 4D detector and latch system 110, however, the nurse or orderly could use a remote control to activate the 4D detector and latch system to automatically hold the door open.

In a first aspect, the 4D detection and latch system 110 could be configured for activation at any time the 4D detectors (e.g., light detecting element 111 or the like) are exposed (e.g., the elevator hoistway doors are opening, open, or in the process of closing), irrespective of whether or not people are entering or leaving the elevator. In one such embodiment, the 4D detection and latch system 110 could require that the person activating the 4D system must actively de-activate the 4D system by again using the transmitter to transmit an appropriate control or carrier signal 120 and re-engage the conventional door control system (e.g., light screen, dwell timer, etc.).

In a second aspect, the 4D detection and latch system 110 could be configured for activation only after the last passenger has entered (or exited), at which time the elevator would automatically hold the door open (e.g., the 4D detection and latch system opens SSR 130 and de-energizes the power supply 500 control relay) for a predetermined period (e.g., 15 seconds), at which time the 2D system is automatically reactivated following passage of the 4D system user and conveyed person or object through the light screen, as determined by the relay line drop detector 140 in a manner known to those of ordinary skill in the art. In other words, the 2D light screen is itself configured to automatically reset the 4D detection and latch system latching circuit and requires no additional input by the user. Using this technique, the 2D light screen system does not require a preset dwell timer (which would have a detrimental effect on the elevator efficiency or throughput) to ensure safe entry or exit and the 4D detection and latch system provides the exact time required for safe passage. Therefore, the 4D detection and latch system, when properly used, does not add any unnecessary time to the loading cycle of the elevator and promotes maximum efficiency of the elevator.

The 4D detection and latch system 110 may also advantageously include a reset timer configured to issue a reset command if the 2D light screen is not interrupted for a set period of 15, time after the 4D detection and latch system is activated. The reset timer would accommodate those instances where a person might intentionally or inadvertently send a signal to the 4D detection and latch system then decide not to enter the elevator.

Thus, the above-described 4D detection and latch system permits a person to remotely command the elevator doors not to close, under any circumstances (e.g., overriding elevator door dwell timers or control buttons), until the person has safely entered (or exited) the elevator. This overcomes the inability of the conventional 3D system to provide guaranteed safe passage past the hoistway and elevator car doors into the elevator cab, which is of particular benefit to hotels, hospitals, retirement homes, and freight elevators, and avoids the unnecessary complications, expense, and delays associated with conventional 3D systems that attempt to intuit or sense the environment surrounding the elevator landing.

Significantly, the above-described 4D detection and latch system requires no additional installation burden, as it utilizes existing 2D light screen housings, cabling systems, power supply, and control relays, making the cost of the system affordable. In this regard, as the disclosed 4D detection and latch system is mobile (i.e., travels with the elevator), only one system needs to be provided for each elevator.

Thus, the above method and system of elevator door control presents examples of implementations of the present concepts, which are not limited to such examples or implementations. It should be recognized that, while the invention has been described in relation to the various aspects thereof, the invention encompasses a wide variation of aspects and details as set forth in the appended claims, which are to be construed to cover all equivalents falling within the true scope and spirit of the invention described by way of examples herein. For example, the present concepts are not limited to the examples of IR control and the 4D detection and latch system includes activation/energization (or deactivation/deenergization), as appropriate to the circuit, accomplished by any variety of carrier wave (e.g., microwave, light waves, RF waves, or mechanical/compressional waves) of any frequency and/or energy, as applicable to the environment in which the elevator is used (e.g., hospital or industrial settings might prefer to avoid RF so as to avoid the potential for inadvertent interaction of the 4D system with other equipment). For example, the presently disclosed 4D detector and latch system includes within its scope spoken commands or coded messages (i.e., mechanical/compressional carrier waves), whether from any person or from designated individuals (e.g. voice recognition), as well as distinct non-verbal commands or coded messages within the range of human hearing.

Broadly stated, the 4D detection and latch system includes within its scope any remote means (i.e., not including manually holding the elevator doors open) by which the elevator door closure is placed exclusively, albeit temporarily, in the hands of the user.

1. An elevator door control system comprising:
an elevator door controller for controlling closure of an elevator door;
a light source array attachable to an elevator car;
a light beam receiver array attachable to an elevator car, the light beam receiver array comprising an output to an elevator door controller;
a switch provided in series with the light beam receiver array output to the elevator door controller; and
a signal detector disposed on said light beam receiver array to detect a control signal borne by a carrier wave emitted by a transmitter and configured to output a signal to one of a controller and said switch in response to a detected control signal,
wherein, responsive to the signal output by the signal detector, said switch changes from one of a first state and a second state to another of said first state and said second state.

2. An elevator door control system according to claim 1:
wherein said second state of said switch causes said elevator door controller to open a closing elevator door or to maintain an open elevator door in an open position.

3. An elevator door control system according to claim 2:
wherein said first state of said switch causes control of said elevator door controller to pass to said light beam receiver array;

4. An elevator door control system according to claim 3:
wherein said elevator door controller comprises at least one of a programmable logic controller, an elevator door operator input device, a power supply relay, an elevator control relay, and a synching relay.

5. An elevator door control system according to claim 4:
wherein said elevator door controller comprises a power supply relay,
wherein said switch comprises a solid state relay,
wherein said first state of said switch corresponds to a closed position of said solid state relay,
wherein said second state of said switch corresponds to an open position of said solid state relay, and
wherein said open position of said solid state relay drops the power supply relay.

6. An elevator door control system according to claim 5:
wherein said light beam receiver array comprises a plurality of light detecting photodiodes and a light beam receiver array switch operatively associated with said light beam receiver array output to said elevator door controller,
wherein said light beam receiver array switch assumes a first state when each of said light beam receiver array light detecting photodiodes provides an output signal representative of an incident light beam,
wherein said light beam receiver array switch assumes a second state when any one of said plurality of light beam receiver array light detecting photodiodes does not provide an output signal representative of an incident light beam, and
wherein said second state of said light beam receiver array switch drops the power supply relay.

7. An elevator door control system according to claim 6:
wherein said switch is configured to be reset to said first state from said second state when said light beam receiver array switch assumes said second state.

8. An elevator door control system according to claim 1:
wherein said switch is configured to be reset to said first state from said second state only upon detection by said signal detector of another control signal borne by a carrier wave emitted by said transmitter.

9. An elevator light screen signal detector module comprising:
a first electrical connector;
a second electrical connector;
at least one signal detection element configured to detect a carrier wave bearing a control signal and configured to output a signal in response thereto, and
a switch configured to change from one of a first state and a second state to another of said first state and said second state in response to a signal output by said at least one signal detection element or in response to a control signal from a controller receiving said signal output by said at least one signal detection element,
wherein said first electrical connector is configured to permit electrical connection of said light screen signal detector module to an output of a light screen receiver array,
wherein said second electrical connector is configured to permit electrical connection of said light screen signal detector module to an input of an elevator door controller, and
wherein connection of said first electrical connector of said light screen signal detector module to an output of a light screen receiver array and connection of said second electrical connector of said light screen signal detector module to an input of an elevator door controller places said switch in series with said output of a light screen receiver array.

10. An elevator light screen signal detector module according to claim 9:
wherein said second state of said switch opens an electrical connection between said output of said light screen receiver array and an elevator door controller, causing the elevator door controller receiving an output signal from said output of said light screen receiver array to open a closing elevator door or to maintain an open elevator door in an open position.

11. An elevator light screen signal detector module according to claim 10:
wherein said first state of said switch provides electrical continuity between said output of said light screen receiver array and an elevator door controller permitting a light beam receiver array to which said light screen signal detector module is attached to control the elevator door controller.

12. An elevator light screen signal detector module according to claim 11:
wherein said switch comprises a solid state relay,
wherein said first state of said switch corresponds to a closed position of said solid state relay,
wherein said second state of said switch corresponds to an open position of said solid state relay.

13. An elevator light screen signal detector module according to claim 12:
wherein said switch is configured to be reset to said first state from said second state by a signal output from said output of said light screen receiver array.

14. An elevator light screen signal detector module according to claim 13:
wherein said controller is a processor adapted to execute an instruction set which processes an output from said at least one signal detection element and, in response to said control signal detected by said signal detection element, issues a control signal to said switch to change from one of a first state and a second state to another of said first state and said second state.

15. An elevator light screen signal detector module according to claim 14, further comprising:
an indicating element comprising at least one of an optical and an audible indicating device,
wherein said processor is adapted to execute an instruction set which processes an output from said at least one signal detection element and, in response to said control signal detected by said signal detection element, issues a control signal to said at least one of an optical and an audible indicating device to change state from a deactivated state to an activated state to provide an indication of control signal receipt by the at least one signal detection element.

16. An elevator light screen signal detector module according to claim 15:
wherein said latching element comprises a solid state relay, and
wherein said indicating element comprises a LED element.

17. An elevator door light screen receiver array comprising:
a plurality of light detecting photodiodes, each of the photodiodes being configured to provide an output signal in response to an incident light beam;
a light beam receiver array switch, said switch configured to assume a first state when each of said plurality of detecting photodiodes provides an output signal and configured to assume a second state when any one of said plurality of light detecting photodiodes does not provide said output signal,
a switch provided in series with the light beam receiver array switch;
an output electrical connector connected to an output of at least one of said light beam receiver array switch and said switch, said output electrical connector being configured for electrical connection to an elevator door controller for controlling closure of an elevator door;
a signal detector integrated with said light beam receiver array, said signal detector being configured to output a signal in response to a detected control signal borne by a carrier wave to change a state of said switch from one of a first state and a second state to another of said first state and said second state.

18. An elevator door light screen receiver array according to claim 17:
wherein said second state of said switch opens an electrical connection between an elevator door controller and one of said switch and said light screen receiver array causing the elevator door controller to open a closing elevator door or to maintain an open elevator door in an open position.

19. An elevator door light screen receiver array according to claim 18:
wherein said first state of said switch provides electrical continuity between an elevator door controller and said light screen receiver array causing the elevator door controller to permit said light screen receiver array to control closure of an elevator door.

20. An elevator door light screen receiver array according to claim 19:
wherein said switch comprises a solid state relay,
wherein said first state of said switch corresponds to a closed position of said solid state relay,
wherein said second state of said switch corresponds to an open position of said solid state relay.

21. An elevator door light screen receiver array according to claim 20:
wherein said switch is configured to be reset to said first state from said second state when said light beam receiver array switch assumes said second state.

22. A method of controlling closure of an elevator door comprising the steps of:
emitting a first carrier wave bearing a first control signal from a transmitter,
using said first control signal to energize a switch to perform at least one of a temporary enabling and disabling of an elevator door controller, the energization of said switch causing said elevator door controller drive an elevator door toward an open position or to maintain an elevator door in an open position;
emitting a second carrier wave bearing a second control signal from a transmitter, and
using said second control signal to deenergize said switch to perform at least one of a temporary disabling and enabling of said elevator door controller, the energization of said switch causing said elevator door controller to drive said elevator door toward a closed position.

23. A method of controlling closure of an elevator door comprising the steps of:
emitting a carrier wave bearing a control signal from a transmitter,
using said control signal to energize a switch provided in series to an output of a 2D light screen, the energization of said switch performing at least one of a temporary enabling and disabling of an elevator door controller and causing said elevator door controller drive an elevator door toward an open position or to maintain an elevator door in an open position;
using an output from a 2D light screen to deenergize said switch and correspondingly provide said output of said 2D light screen as a control input to said control said elevator door controller.

24. A method of controlling closure of an elevator door comprising the steps of:
emitting a carrier wave bearing a control signal from a transmitter,
using said control signal to deenergize a switch provided in series to an output of a 2D light screen, the deenergization of said switch performing at least one of a temporary enabling and disabling of an elevator door controller and causing said elevator door controller drive an elevator door toward an open position or to maintain an elevator door in an open position;
using an output from a 2D light screen to energize said switch and correspondingly provide said output of said 2D light screen as a control input to said control said elevator door controller.
